(19) United States
(12) Patent Application Publication
(10) Pub. No.: US 2007/0261106 A1
(43) Pub. Date: Nov. 8, 2007

(54) System and method for performing a delegation operation

(75) Inventors: Jae-Kwon Oh, Seoul (KR); Wuk Kim, Gwacheon-si (KR); Sang-Kyung Sung, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/796,466

(22) Filed: Apr. 27, 2007

(30) Foreign Application Priority Data
Apr. 28, 2006 (KR) 39051/2006

(51) Int. Cl. H04L 9/32

(52) U.S. Cl. 726/4

(57) ABSTRACT

A method in which a delegated client sends a request message containing operation information, a delegated client identity (ID), and a delegating client ID at the time of sending an operation request to a target system. The target system receives the request message and delegation-authorizes the delegated client by examining whether the delegating client is authorized to perform the operation requested by the request message and also whether the delegating client has delegated the authority to perform the operation to the delegated client sending the request message using the delegating client ID included in the request message. A new header is provided which includes ID information of the delegating client in the request message. When receiving the request message, the target system performs a procedure for authenticating and authorizing not only the delegated client but also the delegating client using the delegating client ID.

### PRIORITY

This application claims priority under 35 U.S.C. §119 to an application filed in the Korean Intellectual Property Office on Apr. 28, 2006 and assigned Serial No. 2006-39051, the contents of which are incorporated herein by reference.

### BACKGROUND OF THE INVENTION

1. Field of the Invention

The present invention generally relates to a system and method for performing a delegation operation, and more particularly to a system and method for performing a delegation operation that can authorize a delegated client for requesting an operation and a delegating client for delegating authority to the delegated client in a target system.

2. Description of the Related Art

Two cases based on an eXtensible Markup Language (XML) Configuration Access Protocol (XCAP), draft-ietf-simple-xcap, J. Rosenberg, and a Session Initiation Protocol (SIP), RFC 3261, J. Rosenberg, in a conventional Open Mobile Alliance (OMA) message service environment will be described with reference to FIGS. 1A and 1B. FIGS. 1A and 1B show examples of a conventional OMA messaging service system.

An example of OMA XDM V1.0 Enabler, http://www.openmobilealliance.org/, messaging service system based on the XCAP will be described with reference to FIG. 1A. A general client 110 sends an XCAP PUT request to an XML Document Management Server (XDMS) 120. In OMA XDM V1.0 Enabler, only the client 110 of a user possessing an associated document can access and modify a document stored in the XDMS 120.

An example of OMA Presence SIMPLE V1.0 Enabler, http://www.openmobilealliance.org/, messaging service system based on the SIP will be described with reference to FIG. 1B. A general client 110 sends an SIP PUBLISH message to a presence server 130. In OMA Presence V1.0 Enabler, only the client 110 representing the user whose presence information is of concern can generate the publication request.

Technology for sending an operation request from the general client to a particular target system is being used in the current OMA message service environment. A delegation operation is required in this OMA message service environment. That is, a delegation operation system is required in which a delegated client can send a particular operation request to an associated target system in place of a delegating client when authority is delegated between clients.

### SUMMARY OF THE INVENTION

Therefore, the present invention provides a system and method for performing a delegation operation.

In accordance with an aspect of the present invention, there is provided a system for performing a delegation operation, the system including a delegated client for sending a request message for requesting that a target system should perform an operation, the request message including an identity (ID) of the delegated client and an ID of a delegating client; a proxy server for examining whether the delegated client requesting the operation is authentic using the delegated client ID included in the request message when receiving the request message and forwarding the request message to the target system when the delegated client is authenticated; and the target system for examining whether the delegating client is authorized to perform the operation requested by the request message and also whether the delegating client has delegated the authority to perform the operation to the delegated client sending the request message using the delegating client ID included in the request message when receiving the request message.

In accordance with another aspect of the present invention, there is provided a method for performing a delegation operation in a delegation operation system, the delegation operation system including a delegated client, a delegating client for delegating authority to the delegated client, a proxy server for authenticating the delegated client and then routing the received operation request to the target system when receiving the operation request from the delegated client, and a target system for authorizing the delegated client whether the delegated client is delegated with the authority to perform the operation on behalf of the delegating client and then performing the requested operation, the method including sending, from the delegated client, a request message for requesting that the target system should perform an operation, the request message including an ID of the delegated client and an ID of the delegating client; examining whether the delegated client requesting the operation is authentic using the delegated client ID included in the request message when the proxy server receives the request message and forwarding the request message to the target system when the delegated client is authenticated; and examining whether the delegating client is authorized to perform the operation requested by the request message and also whether the delegating client has delegated the authority to perform the operation to the delegated client sending the request message using the delegating client ID included in the request message when the target system receives the request message.

In accordance with another aspect of the present invention, there is provided a system for performing a delegation operation, the system including a requesting client for sending a request message for requesting that a target system should perform an operation; a proxy server for examining whether the requesting client is authentic when receiving the request message and forwarding the request message to the target system when the requesting client is authenticated; and the target system for determining whether the requesting client is a general client or a delegated client to which a delegating client has delegated authority when receiving the request message, and examining whether the delegating client is authorized to perform the operation requested by the request message and also whether the delegating client has delegated the authority to perform the operation to the delegated client sending the request message using a delegating client ID included in the request message when the requesting client is the delegated client, executing the requested operation when the delegated client is successfully delegation-authorized, and reporting the execution results to the requesting client.

In accordance with yet another aspect of the present invention, there is provided a method for performing a delegation operation in a delegation operation system, the method including sending, from a requesting client, a request message for requesting that a target system should perform an operation; examining whether the requesting client is authentic when a proxy server receives the request message and forwarding the request message to the target system when the requesting client is authenticated; and determining whether the requesting client is a general client or a delegated client to which a delegating client has delegated authority when the target system receives the request message, and examining whether the delegating client is authorized to perform the operation requested by the request message and also whether the delegating client has delegated the authority to perform the operation to the delegated client sending the request message using a delegating client ID included in the request message when the requesting client is the delegated client, executing the requested operation when the delegated client is successfully delegation-authorized, and reporting an execution result to the requesting client.

### BRIEF DESCRIPTION OF THE DRAWINGS

The above and other features and advantages of the present invention will be more clearly understood from the following detailed description taken in conjunction with the accompanying drawings, in which:

FIGS. 1A and 1B illustrate a conventional Open Mobile Alliance (OMA) messaging service system;

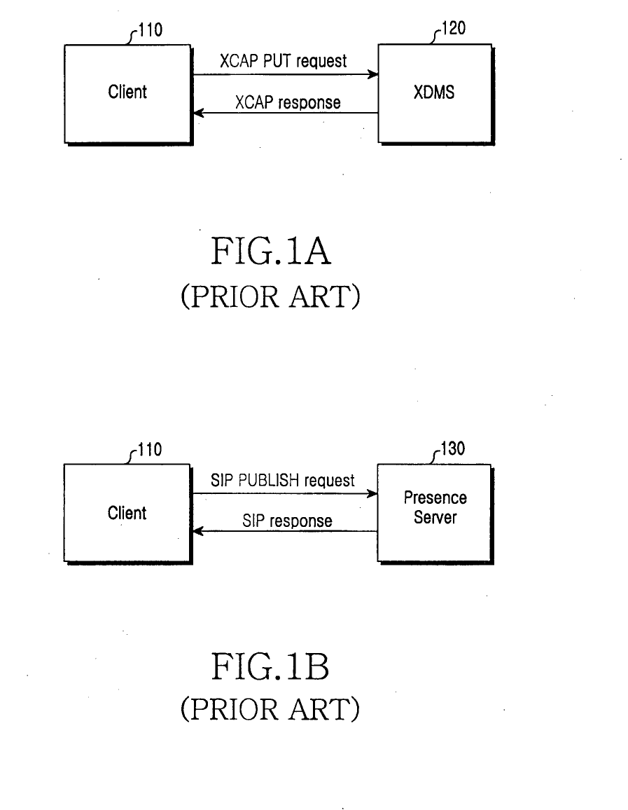

FIG. 2 illustrates a structure of a system for performing a delegation operation to authenticate and authorize a delegating client and a delegated client in accordance with the present invention;

FIG. 3 is a flowchart illustrating a process for performing a delegation operation to authenticate and authorize the delegating client and the delegated client in accordance with the present invention;

FIG. 4 illustrates a structure of a system for processing an Extensible Markup Language (XML) Configuration Access Protocol (XCAP) request when the delegated client sends the XCAP request to a target system in accordance with the present invention; and

FIG. 5 illustrates a structure of a system for processing a Session Initiation Protocol (SIP) request when the delegated client sends the SIP request to a target system in accordance with the present invention.

### DETAILED DESCRIPTION OF THE PREFERRED EMBODIMENTS

The present invention provides a method and system that can efficiently authenticate and authorize not only a delegated client but also a delegating client for delegating authority to the delegated client when the delegated client sends an operation request to a particular target system on behalf of the delegating client in an Open Mobile Alliance (OMA) messaging system.

In particular, the present invention provides a method in which a delegated client sends a request message containing operation information, a delegated client identity (ID), and a delegating client ID at the time of sending an operation request to a target system and the target system receives the request message and examines whether the delegating client is authorized to perform the operation requested by the request message and also the delegating client has delegated the authority to perform the operation to the delegated client sending the request message using a delegating client ID included in the request message. For this, the present invention provides a new header including ID information of the delegating client in the request message. When receiving the request message, the target system performs a procedure for authenticating and authorizing not only the delegated client but also the delegating client using the delegating client ID.

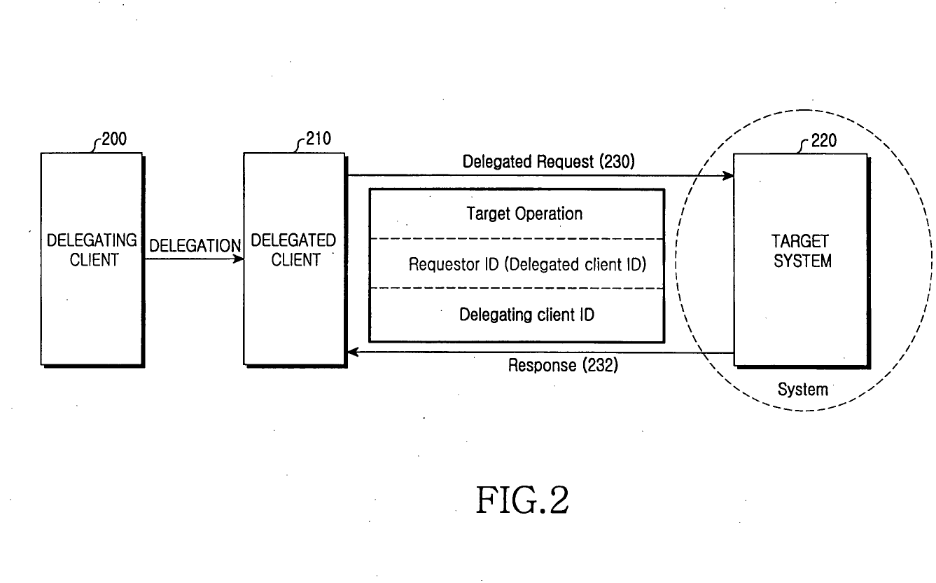

The present invention will be described below with reference to the accompanying drawings. FIG. 2 shows a system for authenticating and authorizing a delegated client in accordance with the present invention.

The delegated client 210 is the client to which the delegating client 200 has delegated the authority to perform an operation. The delegated client 210 can send an operation request to the target system 220 in place of the delegating client 200. When the delegated client 210 sends a request message to the target system 220, the request message contains operation information, a delegated client ID, and a delegating client ID.

When receiving the request message containing the above-described information, the target system 220 examines whether the associated delegated client is authentic. If the delegated client is authenticated, the target system 220 verifies whether the delegating client 200 is authorized to make the operation request and the delegated client 210 is authorized to delegate the authority to make the operation request on behalf of the delegating client 200.

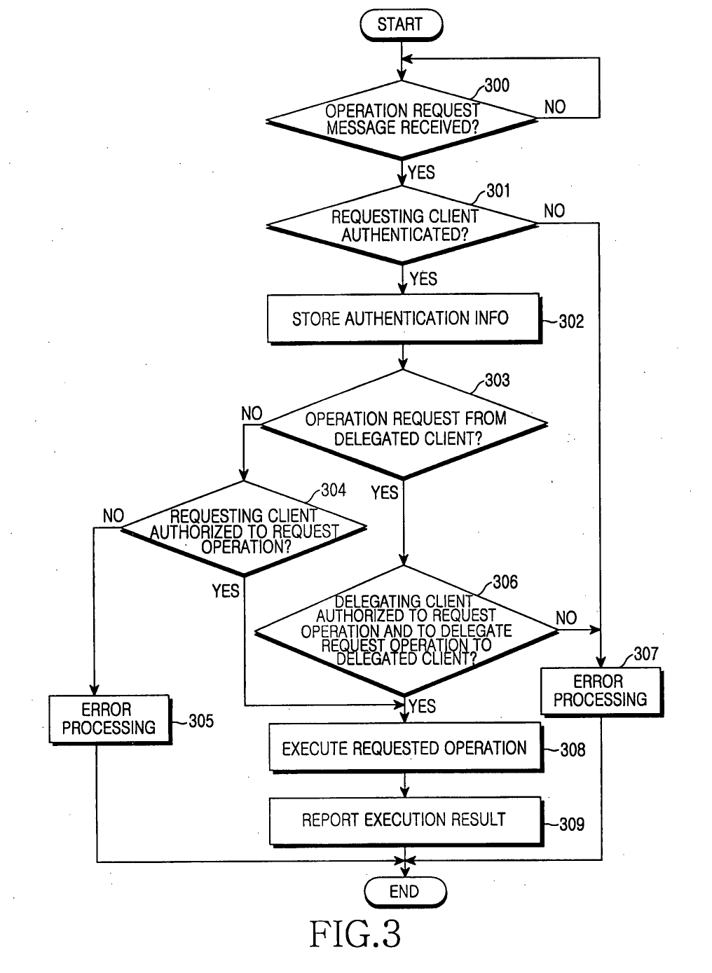

An operation in which the target system 220 receives and processes the operation request message from the delegated client 210 will be described with reference to FIG. 3. FIG. 3 shows an operation for processing an operation request when the target system receives the operation request from a requesting client in accordance with the present invention.

When receiving the operation request message in step 300, the target system 220 proceeds to step 301 to authenticate the requesting client corresponding to the sender of the request message.

If the requesting client is authenticated, the target system 220 proceeds to step 302 to store in the request message the information indicating that the requesting client has been authenticated with respect to the associated request message. The additional authentication process for the same request message within the same system or between trusted systems can be omitted by referencing this information in the same request message.

When proceeding from step 302 to step 303, the target system 220 determines whether the operation request is the request from the delegated client. That is, the target system 220 determines whether the requesting client is the general client or the delegated client to which the delegating client has delegated the authority to perform the operation request.

If the operation request is determined to be the request from the delegated client in step 303, the target system 220 proceeds to step 306. Otherwise, the target system 220 proceeds to step 304 to determine whether the requesting client is authorized to perform the requested operation. If the requesting client is authorized to perform the requested operation, the target system 220 proceeds to step 308. If it is determined that the requesting client is not authorized to request the operation, the target system 220 proceeds to step 305 to perform error processing. The authority is verified by a predefined system policy. For example, in a current OMA Extensible Markup Language (XML) Document Management (XDM) V1.0 Enabler, an owner of information stored in an XML Document Management Server (XDMS) can make all types of XML Configuration Access Protocol (XCAP) requests for accessing and modifying the information. Thus, with this policy, an authentication examination relating to the request needs to only consider whether the requesting client is an owner of the associated information.

If the operation request is determined to be the request from the delegated client in step 303, the target system 220 determines whether the delegating client is authorized to perform the requested operation and if so, whether the delegating client has delegated the authority to perform the requested operation to the delegated client in step 306. That is, if the associated operation request is the request from the delegated client rather than the general client, the target system 220 examines whether the delegating client is authorized to perform the requested operation according to the predefined system policy. Further, along with this authorization examination on the delegating client, the target system 220 performs an authorization examination as to whether the delegated client is authorized to perform the requested operation in place of the delegating client.

As the delegation of the authority to perform some operations to other clients is the unique right of the delegating client, there can be two kinds of authorization methods to verify such delegation, which are: proactive authorization and reactive authorization. In the proactive authorization method, an authorization procedure on the delegation is performed based on the authorization rules predefined in the system by the delegating client. Such authorization rules include the information about the delegating client delegating which authorities to which clients. When this information is described in XML, it can be stored in advance in an associated XDMS. In the reactive authorization method, the system directly inquires the delegating clients for the information about the authority assigned to the delegated client such that the delegation authorization can be verified.

If all conditions for the delegating client are verified in step 306, the target system 220 proceeds to step 308 to execute the requested operation and then proceeds to step 309 to report an execution result to the requesting client through a response message.

In the present invention, the delegated client 210 includes operation information, a delegated client ID, and a delegating client ID in the request message and sends the request message to the target system 220. When receiving the request message, the target system 220 can authenticate and authorize not only the delegated client but also the delegating client using the operation information, the delegated client ID, and the delegating client ID contained in the request message.

When the delegated client 210 sends a particular operation request to the target system 220, the ID of the delegated client 210 and requested operation information are included and transmitted in a header of the request message. In the present invention, the header of the request message to be transmitted further includes the delegating client ID for identifying the delegating client in addition to the delegated client ID and the operation information. Thus, the present invention provides a new header to include three types of information.

The header including the client ID and the requested operation information to be transmitted will be described with reference to Table 1 when the general client issues an operation request.

TABLE 1

| | | Headers that deliver the Requestor |
|---|---|---|
| | | Identity (These Headers deliver |
| | | Delegated User Identity in case of |
| | | Delegated Request) |
| XCAP | Legacy | X-XCAP-Asserted-Identity |
| request | Network | |
| | IMS Network | X-3GPP-Intended-Identity, or |
| | | X-3GPP-Asserted-Identity |
| SIP request | Legacy | P-Preferred-Identity, or |
| | Network | P-Asserted-Identity |
| | IMS Network | P-Preferred-Identity, or |
| | | P-Asserted-Identity |

Table 1 shows the conventional headers for transmitting ID information of a requesting client in the XCAP and SIP requests in the legacy network and the Internet Protocol (IP) Multimedia Subsystem (IMS) network.

The X-XCAP-Asserted-Identity header is an extension of a Hyper Text Transfer Protocol (HTTP) header defined in OMA XDM V1.0 Enabler and is used to transmit the ID information of the requesting client from an XML Document Management Client (XDMC) to an XDMS in the legacy network. The transmitted requesting client ID information is used for authenticating and authorizing the requesting client sending an associated XCAP request.

Further, the X-3GPP-Intended-Identity or X-3GPP-Asserted-Identity header is an extension of an HTTP header defined in 3^{rd} Generation Partnership Project (3GPP) Technical Specification (TS) 24.109 “Technical Specification Group Core Network and Terminals: Bootstrapping interface (Ub) and network application function interface (Ua): Protocol details (Release 6)”, and is used to transmit the ID information of the requesting client relating to an HTTP request (or an XCAP request implemented based on the HTTP request) from an HTTP client to an HTTP server in the IMS network. Similarly, the transmitted ID information of the requesting client is used for authenticating and authorizing the requesting client sending an associated HTTP request. The X-3GPP-Intended-Identity header is used to transmit the ID information of the requesting client that the requesting client wishes to use for the authentication and authorization in the system on the requesting client. On the other hand, the X-3GPP-Asserted-Identity header is used to transmit an authenticated requesting client ID provided from the system when an client ID desired by the requesting client has not been transmitted, i.e., the X-3GPP-Intended-Identity header has not been used.

Further, the P-Preferred-Identity or P-Asserted-Identity header is an extension of an SIP header defined in Request For Comments (RFC) 3325 “Private Extensions to the Session Initiation Protocol (SIP) for Asserted Identity within Trusted Networks”, and is used to transmit the requesting client ID information of the SIP request from a User Agent Client (UAC) to a User Agent Server (UAS) in the legacy network and the IMS network. The transmitted requesting client ID information is used for authenticating and authorizing the requesting client sending an associated SIP request. At this time, the P-Preferred-Identity header is used to transmit requesting client ID information that has not yet been authenticated in the system. The requesting client ID information that has been successfully authenticated in the system is transmitted in the P-Asserted-Identity header.

The header shown in Table 1 is used to transmit ID information of the requesting client, or the delegated client in case of the delegated request message. Thus, the above-described method does not transmit, to the system, ID information of the delegating client that has delegated the authority to the delegated client.

Thus, the present invention provides a header for transmitting the ID information of the delegating client to the system. For this, header extensions to be used for the XCAP and SIP requests in the legacy network and the IMS network are shown in Table 2. Table 2 is based on the technology of Table 1. The header including the delegating client ID information is referred to as Delegation Header in this invention. The Delegation Header will be described with reference to Table 2.

TABLE 2

| | | Header that delivers Delegating User |
|---|---|---|
| | | Identity |
| XCAP | Legacy | X-XCAP-Intended-Delegated-Identity |
| request | Network | |
| | IMS Network | X-3GPP-Intended-Delegated-Identity |
| SIP request | Legacy | P-Intended-Delegated-Identity |
| | Network | |
| | IMS Network | P-Intended-Delegated-Identity |

The X-XCAP-Intended-Delegated-Identity header of Table 2 is mapped to the X-XCAP-Asserted-Identity header of Table 1, and is an extension of an HTTP header. When the delegated client sends an XCAP request to the system in the legacy network, the X-XCAP-Intended-Delegated-Identity header is used to transmit the ID information of the delegating client from an XDMC to an XDMS. The target system uses the transmitted delegating client ID to authenticate and authorize the delegating client with respect to the XCAP request from the associated delegated client as in step 306 of FIG. 3.

Further, the X-3GPP-Intended-Delegated-Identity header of Table 2 is mapped to the X-3GPP-Intended-Identity header of Table 1, and is an extension of an HTTP header in the IMS network. The X-3GPP-Intended-Delegated-Identity header is used to transmit the ID information of the delegating client from an HTTP client to an HTTP server when an HTTP request (or an XCAP request implemented based on the HTTP request) is transmitted from the delegated client to the system. The transmitted delegating client ID is used as information for authenticating and authorizing the delegating client according to the HTTP request from the associated delegated client to the system as in step 306 of FIG. 3.

Further, the P-Intended-Delegated-Identity header of Table 2 is mapped to the P-Preferred-Identity header of Table 1, and is an extension of the SIP header. The P-Intended-Delegated-Identity header is used to transmit the ID information of the delegating client from the UAC to the UAS in the legacy network and the IMS network. The transmitted delegating client ID is used as information for authenticating and authorizing the delegating client according to the SIP request from the associated delegated client to the system as in step 306 of FIG. 3.

When the delegated client sends a particular operation request to the associated target system, the ID of the delegating client is provided to the target system by including the header of Table 2 in a request message. After receiving the request message, the target system can authenticate and authorize not only the delegated client but also the delegating client when an associated operation is performed. Below are descriptions of examples when the delegated client sends operation requests, such as the XCAP request and the SIP request, to the target system in the present invention.

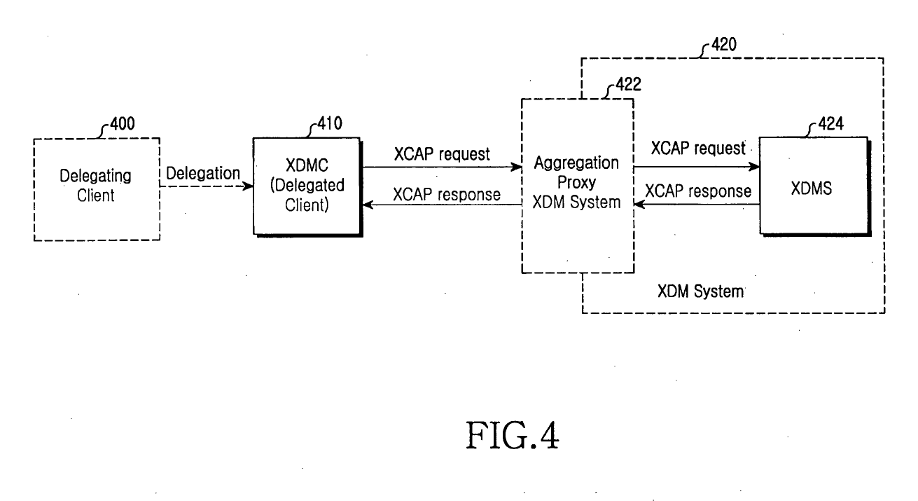

When the delegated client sends the XCAP request to the target system will now be described. An procedures in which the target system processes an associated operation in the XCAP request will be described with reference to FIGS. 3 and 4 when the delegated client is the XDMC and the XDMC sends the XCAP request to the XDMS.

The case where the underlying network is the legacy network will be described with reference to FIG. 4. The XDMC 410 includes its ID in the X-XCAP-Asserted-Identity header according to OMA XDM V1.0 Enabler. In accordance with the present invention, the XDMC 410 generates an XCAP request message in which an ID of the delegating client 400 is included in the X-XCAP-Intended-Delegated-Identity header and then sends the XCAP request message to an aggregation proxy server 422 coupled to the XDMS 424 corresponding to the target system. Further, when the underlying network is the IMS network, the XDMC 410 includes its ID in the X-3GPP-Intended-Identity header according to OMA XDM V1.0 Enabler. In accordance with the present invention, the XDMC 410 generates an XCAP request message in which the ID of the delegating client 400 is included in the X-3GPP-Intended-Delegated-Identity header, and then sends the XCAP request message to the aggregation proxy server 422 coupled to the XDMS 424 corresponding to the target system.

Then, when the underlying network is the legacy network, the aggregation proxy server 422 performs a process for authenticating the requesting client according to OMA XDM V1.0 Enabler using a requesting client ID included in the X-XCAP-Asserted-Identity header, i.e., an ID of the XDMC 410, as in step 301 of FIG. 3. If the authentication is successful, the aggregation proxy server 422 forwards the XCAP request message to the XDMS 424 corresponding to the target system. Further, when the underlying network is the IMS network, the aggregation proxy server 422 performs a process for authenticating the requesting client according to OMA XDM V1.0 Enabler using a requesting client ID included in the X-3GPP-Intended-Identity header, i.e., the ID of the XDMC 410, as in step 304 of FIG. 3. If the authentication is successful, the aggregation proxy server 422 forwards the XCAP request message to the XDMS 424 corresponding to the target system. If the X-3GPP-Intended-Identity header is not included in the request message received by the aggregation proxy server 422, the aggregation proxy server 422 adds in the request message the X-3GPP-Asserted-Identity header with the value set to the authenticated ID of the delegated client 410 after successful authentication of the delegated client 410, and then forwards the request message to the associated target XDMS 424 according to OMA XDM V1.0 Enabler.

Then, by observing in the forwarded XCAP request message the occurrence of the X-XCAP-Intended-Delegated-Identity header or the X-3GPP-Intended-Delegate d-Identity header, the XDMS 424 corresponding to the target system determines that the forwarded XCAP request is a delegated request as in step 303 of FIG. 3, and then authorizes the delegated client 410 and the delegating client 400 using the forwarded XCAP request message as in step 306 of FIG 3. That is, the XDMS 424 examines whether the ID of the delegating client 400 included in the X-XCAP-Intended-Delegated-Identity header or the X-3GPP-Intended-Delegated-Identity header has the authority to perform the requested operation in the forwarded XCAP request message against the target resource. Further, the XDMS 424 examines whether the ID of the delegated client 410 included in the X-XCAP-Asserted-Identity header or the X-3GPP-Intended-Identity header has been delegated by the delegating client 400 with the authority to perform the requested operation in the forwarded XCAP request message. This delegation authorization can be performed by referring to a delegation rules predefined in the XDMS 424 or other place in the system, or by using the reactive delegation authorization.

When successfully authenticating and authorizing the delegating client 400 and the delegated client 410 as to the delegated operation request in the delegated XCAP request message, the XDMS 424 executes according to OMA XDM V1.0 Enabler the requested XCAP operation for the target resource, and then reports the execution results to the aggregation proxy server 422.

Then, the aggregation proxy server 422 forwards the received XCAP response message to the XDMC 410 corresponding to the delegated client according to OMA XDM V1.0 Enabler.

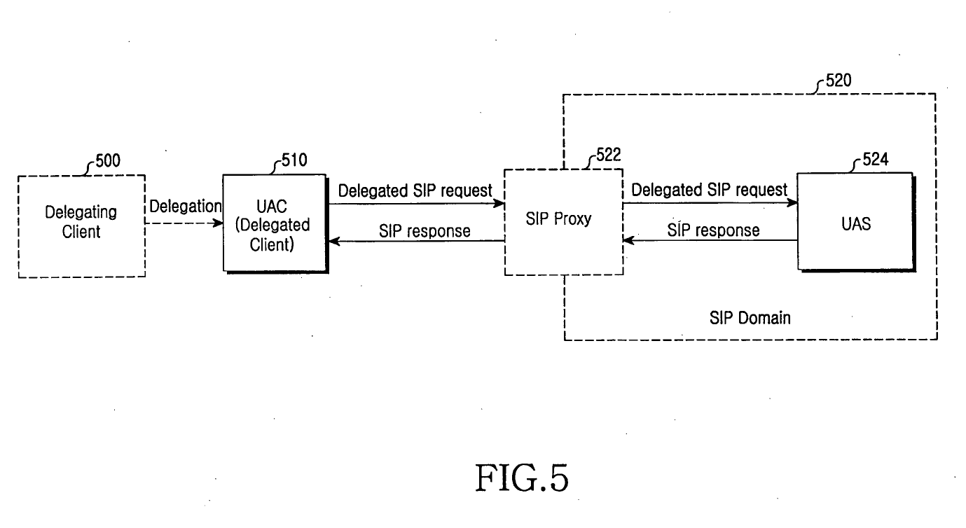

When the delegated client sends the SIP request to the target system will now be described. An procedures in which the target system processes an associated operation will be described with reference to FIGS. 3 and 5 when the delegated client is the UAC and the UAC sends the SIP request to the UAS.

The case where the underlying network is the legacy network or the IMS network will be described with reference to FIG. 5. The UAC 510 includes its ID in the P-Preferred-Identity header according to RFC 3325. The UAC 510 generates an SIP request message in which an ID of the delegating client 500 is included in the P-Intended-Delegated-Identity header and then sends the SIP request message to the target UAS 524 through an SIP proxy server 522 according to RFC 3261.

Then, when receiving the SIP request message, the SIP proxy server 522 for the target UAS 524 examines whether a requesting client is authentic using the ID of the delegated client, i.e., the UAC 510, included in the P-Preferred-Identity header according to RFC 3325. If the UAC 510 corresponding to the requesting client is successfully authenticated, the SIP proxy server 522 removes the P-Preferred-Identity header from the SIP request message according to RFC 3325, generates an SIP request message to which the P-Asserted-Identity header with an ID value of the authenticated requesting client has been added, and forwards the SIP request message to the target UAS 524 according to RFC 3261.

Then, by observing in the forwarded SIP request message the occurrence of the P-Intended-Delegated-Identity header, the target UAS 524 corresponding to the target system determines that the forwarded SIP request is a delegated request as in step 303 of FIG. 3, and then authorizes the delegated client 510 and the delegating client 500 using the forwarded SIP request message as in step 306 of FIG. 3. That is, for the authorization examination relating to the request, the UAS 524 examines whether the associated delegating client 500 whose ID is included in the P-Intended-Delegated-Identity has, the authority to perform the requested operation in the forwarded SIP request message according to a predefined policy. Further, for the authorization examination relating to the delegation, the UAS 524 examines whether the delegating client of the ID included in the P-Intended-Delegated-Identity header has delegated the authority to perform an associated SIP request, to the UAC 510 mapped to the delegated client ID included in the P-Asserted-Identity header. This delegation authorization can be performed by referring to a delegation rules predefined in the system, or by using the reactive delegation authorization.

When successfully authenticating and authorizing the delegating client 500 and the delegated client 510 as to the delegated operation request in the delegated SIP request message, the UAS 524 executes the requested SIP operation according to RFC 3261 and then reports the execution results to the SIP proxy server 522.

Then, the SIP proxy server 522 forwards the received SIP response message to the UAC 510 corresponding to the delegated client according to RFC 3261.

As is apparent from the above description, the present invention provides a new header in which ID information of a delegating client can be transmitted when a delegated client sends a particular operation request to a system. When the delegated client sends the particular operation request to the target system, the delegated client can transmit not only its own ID but also ID information of the delegating client in a request message.

Further, the target system can authenticate and authorize not only the delegated client but also the delegating client by referring to the delegating client ID and the delegated client ID included in the request message according to the particular operation request from the delegated client, thereby protecting the authority of the delegating client and effectively executing a requested operation.

Although preferred embodiments of the present invention have been disclosed for illustrative purposes, those skilled in the art will appreciate that various modifications, additions, and substitutions are possible, without departing from the scope of the present invention. Therefore, other possible embodiments and modifications without departing from the principle of the present invention may fall into the protected scope of the present invention.

What is claimed is:

1. A system for performing a delegation operation, the system comprising:
a delegated client for sending a request message for requesting that a target system should perform an operation, the request message including an identity (ID) of the delegated client and an ID of a delegating client;
a proxy server for examining whether the delegated client requesting the operation is authentic using the delegated client ID included in the request message when receiving the request message and forwarding the request message to the target system when the delegated client is authenticated; and
the target system for examining the delegation authorization of the delegated client using the delegating client ID included in the request message when receiving the request message.

2. The system of claim 1, wherein the request message comprises:
a first header including the delegated client ID; and
a second header including the delegating client ID.

3. The system of claim 1, wherein the request message comprises requested operation information.

4. The system of claim 1, wherein the target system executes the requested operation when the delegated client is successfully delegation-authorized on its authority to perform the requested operation on behalf of the delegating client, and then reports the execution results to the delegated client through the proxy server.

5. The system of claim 1, wherein the delegated client is successfully delegation-authorized when the delegating client is determined to be authorized to perform the requested operation and also when the delegated client is determined to be delegated by the delegating client with the authority to perform the requested operation on be half of the delegating client.

6. A method for performing a delegation operation in a delegation operation system, the delegation operation system including a delegated client, a delegating client for delegating authority to the delegated client, a proxy server for authenticating the delegated client and then routing the received operation request to the target system when receiving the operation request from the delegated client, and a target system for authorizing the delegated client-whether the delegated client is delegated with the authority to perform the operation on behalf of the delegating client and then performing the requested operation, the method comprising the steps of:
sending, from the delegated client, a request message for requesting that the target system should perform an operation, the request message including an identity (ID) of the delegated client and an ID of the delegating client;
examining whether the delegated client requesting the operation is authentic using the delegated client ID included in the request message when the proxy server receives the request message and forwarding the request message to the target system when the delegated client is authenticated; and
examining the delegation authorization of the delegated client using the delegating client ID included in the request message when the target system receives the request message.

7. The method of claim 6, wherein the request message comprises:
a first header including the delegated client ID; and
a second header including the delegating client ID.

8. The method of claim 6, wherein the request message comprises requested operation information.

9. The method of claim 6, further comprising:
executing the requested operation when the delegated client is successfully delegation-authorized on its authority to perform the requested operation on behalf of the delegating client, and then reporting the execution results to the delegated client through the proxy server.

10. The method of claim 6, wherein the delegated client is successfully delegation-authorized when the delegating client is determined to be authorized to perform the requested operation and also when the delegated client is determined to be delegated by the delegating client with the authority to perform the requested operation on be half of the delegating client.

11. A system for performing a delegation operation, the system comprising:
a requesting client for sending a request message for requesting that a target system should perform an operation;
a proxy server for examining whether the requesting client is authentic when receiving the request message and forwarding the request message to the target system when the requesting client is authenticated; and
the target system for determining whether the requesting client is a general client or a delegated client to which a delegating client has delegated authority when receiving the request message, and examining whether the delegating client is authorized to perform the operation requested by the request message and also whether the delegating client has delegated the authority to perform the operation to the delegated client sending the request message using a delegating client identity (ID) included in the request message when the requesting client is the delegated client, executing the requested operation when the delegated client is successfully delegation-authorized, and reporting the execution results to the requesting client.

12. The system of claim 11, wherein the target system examines whether the general client is authorized to perform the requested operation when the requesting client is determined to be the general client after examining whether the requesting client is the general client or the delegated client to which the delegating client has delegated authority, executes the requested operation when the requesting client is successfully authorized to perform the requested operation, and then reports the execution results to the requesting client.

13. A method for performing a delegation operation in a delegation operation system, the method comprising the steps of:
sending, from a requesting client, a request message for requesting that a target system should perform an operation;
examining whether the requesting client is authentic when a proxy server receives the request message and forwarding the request message to the target system when the requesting client is authenticated; and
determining whether the requesting client is a general client or a delegated client to which a delegating client has delegated authority when the target system receives the request message; and
examining whether the delegating client is authorized: to perform the operation requested by the request message and also whether the delegating client has delegated the authority to perform the operation to the delegated client sending the request message using a delegating client identity (ID) included in the request message when the requesting client is the delegated client;
executing the requested operation when the delegating client is successfully delegation-authenticated; and
reporting an execution result to the requesting client.

14. The method of claim 13, further comprising:
examining whether the general client is authorized to perform the requested operation when the requesting client is the general client after the target system examines whether the requesting client is the general client or the delegated client to which the delegating client has delegated authority,
executing the requested operation when the requesting client is successfully authorized to perform the requested operation,
and then reporting the execution results to the requesting client.
